(19) United States
(12) Patent Application Publication
(10) Pub. No.: US 2026/0152069 A1
(43) Pub. Date: Jun. 4, 2026

(54) SYSTEMS AND METHODS FOR ADJUSTING A VIEWING ANGLE OF A DISPLAY DEVICE

(71) Applicant: Harman Becker Automotive Systems GmbH, Karlsbad-Ittersbach (DE)

(72) Inventor: Wieland OBERST, Kraichtal (DE)

(73) Assignee: Harman Becker Automotive Systems GmbH, Karlsbad-Ittersbach (DE)

(21) Appl. No.: 19/465,720

(22) Filed: Jan. 30, 2026

Related U.S. Application Data
(63) Continuation of application No. PCT/IB2023/000505, filed on Aug. 4, 2023.

(51) Int. Cl. B60K 35/81; B60K 35/10; B60K 35/22; B60K 35/29; B60K 35/65; G02F 1/13

(52) U.S. Cl. CPC B60K 35/81; B60K 35/10; B60K 35/22; B60K 35/29; B60K 35/654; G02F 1/1323; B60K 2360/1526; B60K 2360/332; B60K 2360/336

(57) ABSTRACT

A method including the determination of a contrast ratio based on a luminance level and an ambient light associated with a display device, the adjustment of a light based on the contrast ratio, wherein the light is emitted from a front light guide, and the direction of the adjusted light toward a driver associated with a vehicle, wherein directing the adjusted light toward the driver causes the display device to display an image more visibly to a passenger associated with the vehicle than the driver.

### CROSS-REFERENCE TO RELATED APPLICATIONS

This application is a continuation of International Application No. PCT/IB2023/000505, filed on Aug. 4, 2023. The disclosures of the above applications are incorporated herein by reference.

### FIELD

The present disclosure relates to a display device, and more particularly, to systems and methods for adjusting a viewing angle of the display device.

### BACKGROUND

The statements in this section merely provide background information related to the present disclosure and may not constitute prior art.

A display device can present privacy issues when used in public settings. For example, a user of the display device may be viewing private and/or confidential information that the user does not want another person to also view. Privacy lenses and films have been used as solutions to prevent others from viewing the display device. These lenses or films are typically placed on the display device (or in the backlight stack) to provide harder-to-read screens for unintended viewers but can also reduce the viewing quality for the user themselves.

### SUMMARY

This section provides a general summary of the disclosure and is not a comprehensive disclosure of its full scope or all its features.

The present disclosure provides a method of the above paragraph, which may be implemented individually or in any combination, the method includes determining, based on a luminance level and an ambient light associated with a display device, a contrast ratio; adjusting, based on the contrast ratio, a light, wherein the light is emitted from a front light guide; and directing the adjusted light toward a driver associated with a vehicle, wherein directing the adjusted light toward the driver causes the display device to display an image more visibly to a passenger associated with the vehicle than the driver; further comprising: determining, based on the light, an updated contrast ratio; and adjusting, based on the light and the updated contrast ratio, a concentration of the light directed toward the driver; wherein the luminance level indicates an intensity of light emitted from a backlight associated with the display device; wherein adjusting the light further comprises: adjusting, based on the contrast ratio, a brightness of the light emitted from the front light guide, wherein adjusting the brightness of the light comprises at least one of increasing the brightness of the light or decreasing the brightness of the light; wherein the front light guide is a film that is comprised of an array of light emitting diodes (LEDs) disposed at one or more edges of the front light guide; wherein the front light guide is disposed between at least one pixel of the plurality of pixels and a cover lens, wherein the luminance level and the ambient light is associated with the at least one pixel of the plurality of pixels; wherein each of the array of LEDs emit an equal concentration of light.

The present disclosure provides a system comprising a controller configured to: determine, based on a luminance level and an ambient light associated with a display device, a contrast ratio, adjust, based on the contrast ratio, a light, wherein the light is emitted from a front light guide, and cause the adjusted light to be directed toward a driver associated with a vehicle, wherein directing the adjusted light toward the driver causes the display device to display an image more visibly to a passenger associated with the vehicle than the driver; and a front light guide configured to: direct the adjusted light toward the driver; wherein the controller is further configured to: determine, based on the light, an updated contrast ratio; and adjust based on the light and the updated contrast ratio, a concentration of the light directed toward the driver; wherein the luminance level indicates an intensity of light emitted from a backlight associated with the display device; wherein the controller configured to adjust the light is further configured to: adjust, based on the contrast ratio, a brightness of the light emitted from the front light guide, wherein adjusting the brightness of the light comprises at least one of increasing the brightness of the light or decreasing the brightness of the light; wherein the front light guide is a film that is comprised of an array of light emitted diodes (LEDs) disposed at one or more edges of a film; wherein the front light guide is disposed between at least one pixel of the plurality of pixels and a cover lens, wherein the luminance level and the ambient light is associated with the at least one pixel of the plurality of pixels; wherein each of the array of LEDs emit an equal concentration of light.

The present disclosure provides one or more non-transitory computer-readable media storing processor-executable instructions that, when executed by at least one processor, cause the at least one processor to determine, based on a luminance level and an ambient light associated with a display device, a contrast ratio; adjust, based on the contrast ratio, a light, wherein the light is emitted from a front light guide; and direct the adjusted light toward a driver associated with a vehicle, wherein directing the adjusted light toward the driver causes the display device to display an image more visibly to a passenger associated with the vehicle than the driver; wherein the at least one processor is further caused to: determine, based on the light, an updated contrast ratio; and adjust, based on the light and the updated contrast ratio, a concentration of the light directed toward the driver; wherein the luminance level indicates an intensity of light emitted from a backlight associated with the display device; wherein the front light guide is a film that is comprised of an array of light emitting diodes (LEDs) disposed at one or more edges of the front light guide; wherein the front light guide is disposed between at least one pixel of the plurality of pixels and a cover lens, wherein the luminance level and the ambient light is associated with the at least one pixel of the plurality of pixels; wherein the processor-executable instructions, that when executed by the at least one processor, adjust the light, further cause the at least one processor to: adjust, based on the contrast ratio, a brightness of the light emitted from the front light guide, wherein adjusting the brightness of the light comprises at least one of increasing the brightness of the light or decreasing the brightness of the light.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram of an electro-optical lens in accordance with one or more embodiments;

FIG. 2 illustrates electro-optical lens adjustment by applying an electric field in accordance with one or more embodiments;

FIG. 3 illustrates a lens array having a plurality of electro-optical lenses in accordance with one or more embodiments;

FIG. 4 illustrates a display device in accordance with one or more embodiments;

FIG. 5 illustrates a viewing angle of the display device in accordance with one or more embodiments;

FIG. 6 illustrates a light distribution of the electro-optical lens in accordance with one or more embodiments; and

FIG. 7 is a flowchart illustrating an example method for operating a display device in accordance with one or more embodiments.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Systems and methods for adjusting a viewing angle of a display device are described herein. The systems are configured to control the emission of a light emitted from a light guide that aids in the contrasting of a luminance of a display viewable by a driver of a vehicle. That is, in one or more implementations, a contrast level is adjusted in a direction where privacy from viewing is desired or required to thereby block or prevent viewing from that direction. For example, a switchable privacy display with active contrast reduction is provided. With the use of the front light guide, in various implementations, the display device provides the passenger with privacy adherent to industry standards and legal regulations, while offering the passenger an easy to see image and preventing a driver from seeing the same image.

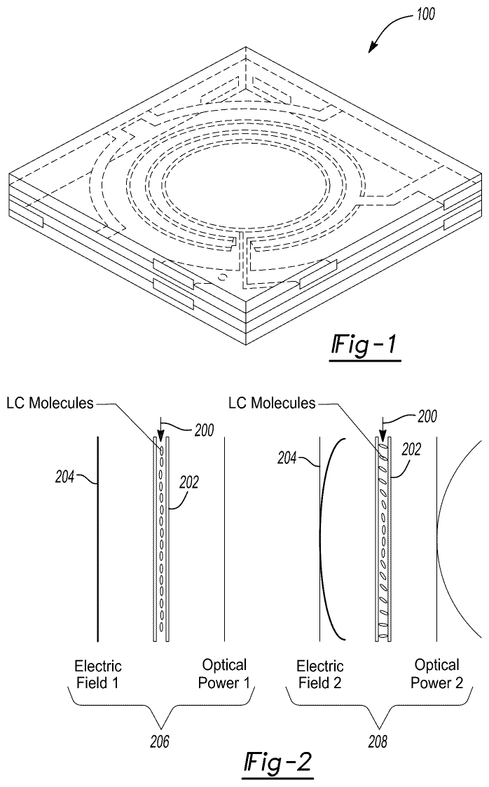

Referring to FIGS. 1 and 2, an electro-optical lens 100 is depicted. The electro-optical lens 100 is comprised of a plurality of electrically driven sub-lenses (not shown). Each of the electrically driven sub-lenses is capable of being tuned via optical power. For example, each of the sub-lenses may be a Liquid Crystal (LC) lens. In one or more embodiments, the LC lens is comprised of a plurality of LC molecules 200. As another example, each of the sub-lenses may be an organic light-emitting diode (OLED) lens or any other type of lens that is capable of being tuned via optical power. However, it is understood that each of the sub-lenses may not necessarily be electrically driven or comprised of only one type of lens (e.g., LC lens and/or OLED lens).

The electrically driven sub-lenses include at least one LC layer 202 between transparent substrates. For example, the optical power of the transparent substrates can be controlled by applying an operating voltage to the LC layer 202. A refractive index of the LC layer 202 is changed based on an alignment state of the LC layer 202 being adjusted. A refractive power of the LC layer 202 is also changed based on the alignment state of the LC layer 202 being adjusted. In one or more embodiments, a top layer of the electro-optical lens 100 is a cover lens (not shown).

Referring particularly to FIG. 2, an adjustment of optical power of the electro-optical lens 100 is illustrated. For example, applying an electric field to the electro-optical lens 100 adjusts the optical power of the electro-optical lens 100.

In operation, when an electric field 204 is applied, the LC layer 202 is electrically controlled and utilized to provide a defined optical power over an optically active area of the electro-optical lens 100 by aligning optically active LC molecules of the plurality of LC molecules 200 in the LC layer 202. For example, an operating voltage may be applied to electrically control the LC layer 202. In some examples, the optical power is predefined. As an example, the orientation of the plurality of LC molecules 200 are changed based on the intensity of the operating voltage applied to the LC layer 202.

As an example, when the LC layer 202 is in an off-state 206 (e.g., not powered or active), the plurality of the LC molecules 200 are in a homogeneous (e.g., a neutral) conformity relative to each of the LC molecules 200 within the plurality of LC molecules 200. Functionally, the off-state 206 of the LC layer 202 allows for light to pass through the LC layer 202, absent of any retardation of the light. In operation, when the LC layer 202 is in an on-state 208, the plurality of LC molecules 200 are not in a homogenous conformity, the light passing through the LC layer 202 may retard (e.g., may change the direction of the light passing through the LC layer 202). For example, to control a retardation of the light through the LC layer 202, a plurality of electrodes (not shown) may be arranged on the substrates and used to finely control the electrical field on the LC layer 202. For example, the plurality of electrodes allow for the electric field on the LC layer 202 to be accurately manipulated to control the retardation of the light through the LC layer 202. The plurality of electrodes may be any number of electrodes and may be arranged in different configurations as desired or needed.

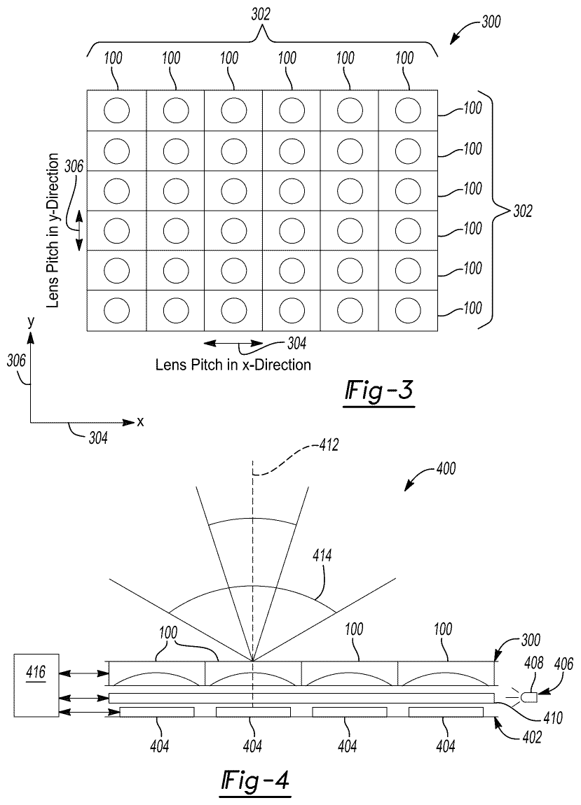

Referring to FIG. 3, a lens array 300 is shown. The lens array 300 is comprised of a plurality of electro-optical lenses 302 (e.g., more than one electro-optical lens 100). For example, the lens array 300 comprising the plurality of electro-optical lenses 302 is arranged as a two-dimensional (2D) lens array. FIG. 3 depicts the plurality of electro-optical lenses 302 in a rectangular matrix, along an x-direction 304 and a y-direction 306 perpendicular to each other, with each electro-optical lens 100 having a rectangular shape. However, the plurality of electro-optical lenses 302 may be arranged in any geometrical orientation and is not limited to a specific shape. For example, the plurality of electro-optical lenses 302 can have a hexagonal shape or be integrally formed in an array on substrates including a plurality of electrodes, such as a micro-lens array. It should be appreciated that the optical active area of the electro-optical lens 100 is not limited to a specific shape or configuration.

As is specifically depicted in FIG. 3, the lens array 300 may have a planar surface and is defined by the x-direction 304 and the y-direction 306, which are axes that are perpendicular to each other as described herein. Along the x-direction 304, the plurality electro-optical lenses 302 are arranged in a lens pitch in the x-direction 304. Along the y-direction 306, the plurality of electro-optical lenses 302 are arranged in a lens pitch in the y-direction 306. For example, the lens pitches denote the width, or distance, in the respective direction, after which the following lens is arranged.

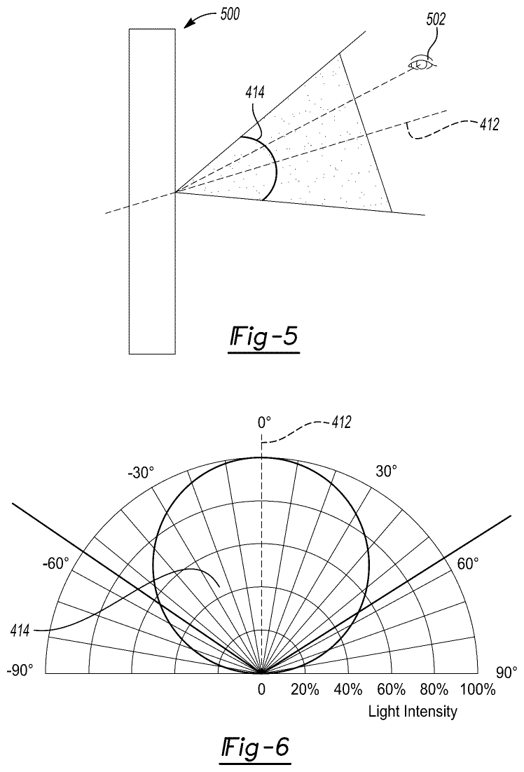

Referring to FIGS. 4 and 5, a display device 400 is illustrated as including a display unit 402. The display unit 402 includes a plurality of pixels 404 for displaying image information to a user 502 (e.g., a viewer) looking at the display device 400. However, the plurality of pixels 404 may be used to display image information (or other information) regardless of whether the user 502 is looking at the display device 400. The plurality of pixels 404 emit light, which is collected and emitted towards a user 502, by optical imaging elements (not shown) collimating or widening the light into a light beam. In one or more embodiments, the optical imaging elements are the electro-optical lenses 100.

The display unit 402 also includes a light guide, illustrated as a front light guide 406, which is provided as a layer adjacent to the plurality of pixels 404 (e.g., positioned above or outward from the plurality of pixels 404). That is, the front light guide 406 is positioned in the direction of any light emitted by the plurality of pixels 404, namely between the user 502 and the display unit 402. The front light guide 406 is a combination of an array of lights 408 and a film 410. In an embodiment, the array of lights 408 are light-emitting diodes (LEDs). It is understood, however, that the front light guide 406 may incorporate a single LED as well. The combination of the array of lights 408 and the film 410 are used so that the front light guide 406 is as thin as possible so that the thickness of the overall display device 400 is not significantly increased. In an embodiment, the front light guide 406 implements an edge lighting formation, wherein the array of lights 408 surround the edges of the film 410 and output light so that the light transfers through the film 410 via the edges of the film 410. In another embodiment the array of lights 408 are positioned along one edge of the film 410 and output light so that the light transfers through the film 410. It is understood that in either configuration, the front light guide 406 is designed in a way that may direct light in particular directions. For example, the front light guide 406 may be designed so that a higher concentration of light is directed toward a driver of a vehicle than a concentration of light directed to a passenger of the vehicle. As another example, the front light guide 406 may be designed so that a higher concentration of light is directed toward the passenger of the vehicle than a concentration of light directed to the driver of the vehicle. As an additional example, the front light guide 406 may be designed in a way that an equal concentration of light is provided to both the driver of the vehicle and the passenger of the vehicle.

In one or more embodiments, the front light guide 406 is configured to allow for one or more settings to be programmed, which would instigate a predefined action. As an example, the predefined action may be actions associated with a privacy mode setting and/or a share-mode setting. For example, in response to the privacy mode setting being selected, such as by a user, one or more settings cause the front light guide 406 to direct a higher concentration of light toward the driver of the vehicle. That is, the passenger of the vehicle will be able to see the contents of the display while the driver of the vehicle will not be able to see the contents of the display. In response to the share-mode setting being selected, one or more settings cause the front light guide 406 to provide an equal concentration of light to both the driver of the vehicle and the passenger of the vehicle. That is, both the passenger of the vehicle and the driver of the vehicle will be able to see the contents of the display. It is understood that the front light guide 406 may be programmed with any other setting as well. That is, the front light guide 406 can be configured and/or controlled in many different ways. For example, the front light guide 406 can direct a high concentration of light toward the driver of the vehicle. That is, the passenger of the vehicle will not be able to see the contents of the display while the driver of the vehicle will be able to see the contents of the display.

Above the front light guide 406, in other words in the direction of the emitted light by the plurality of pixels 404, namely between the user 502 and the display unit 402, the lens array 300 is arranged. The lens array 300 includes the plurality of electro-optical lenses 302, wherein each of the plurality of electro-optical lenses 302 is associated with at least one of the plurality of pixels 404. Each of the electro-optical lenses 100 of the plurality of electro-optical lenses 302 collects the emitted light from one or more of the plurality of pixels 404 and emits the collected light along an optical projection axis 412 of each electro-optical lens 100 of the plurality of electro-optical lenses 302. In various examples, each electro-optical lens 100 may collect light from at least one pixel, or from the plurality of pixels 404. For example, each electro-optical lens 100 of the plurality of electro-optical lenses 302 may collect and emit the light of only one of the plurality of pixels 404. In other words, there may be a one-to-one correspondence between the pixels and adjustable electro-optical lenses in some examples.

Each electro-optical lens 100 of the plurality of electro-optical lenses 302 emits the light forward along the optical projection axis 412 within a viewing angle 414. For example, the viewing angle 414 may be defined as an angle in which the display information displayed on the display device 400 can be seen by the user 502. In other words, the viewing angle 414 includes all directions in which the light intensity of the emitted light, or a contrast of the display, is over a predefined threshold. For example, the predefined threshold may be 25%, 10%, 5%, or 1% of a maximum light intensity of the emitted light, or the maximum contrast of the display. As another example, the predefined threshold may be any amount of the maximum light intensity of the emitted light. As such, in various examples, readability or viewability of the display from particular angles is defined by contrast and not only by luminance. That is, one or more examples actively reduce the perceived contrast by emitting homogeneous light in one or more directions, such as towards the driver of a vehicle, thereby resulting in optical noise in the direction of the driver. However, it is understood that a luminance level may vary the contrast of brightness of the image.

As is illustrated, for symmetrical light distributions, the viewing angle 414 may be an angle including the optical projection axis 412. The optical projection axis 412 may be the center of the viewing angle 414. In various examples, the emitted light has a light distribution, or in other words a light intensity distribution over angle, which may be symmetrical to the optical projection axis 412.

The optical projection axis 412 extends perpendicular to the surface of the display device 400. However, it is understood that the optical projection axis 412 may also be directed in a defined (e.g., predetermined) bias angle from the perpendicular direction at the surface of the display device 400.

In one or more examples, each electro-optical lens 100 of the plurality of electro-optical lenses 302 is configurable in an angular way relative to the optical projection axis 412. For example, a first electro-optical lens may be configured at a different angle than a second electro-optical lens so that there may be more than one viewing angle.

The display device 400 also includes a controller 416 that communicates to each of the plurality of pixels 404, the front light guide 406, and the electro-optical lens 100. The controller 416 is configured to adjust the luminance of the light emitted from the plurality of pixels 404. For example, the adjustment of the luminance of the light emitted from the plurality of pixels 404 is based on the intensity of the emitted light from the plurality of pixels 404. The controller 416 also causes the image to be displayed more visibly to the passenger than the driver. For example, the image is displayed more visibly to the passenger than the driver based on the adjusted luminance and the light emitted from the front light guide 406. As a further example, the image may be displayed more visibly to the passenger than the driver based on the adjusted luminance and/or the light emitted from the front light guide 406. It is understood that the image may be displayed so that the image is equally as visible to the passenger and the driver as well. The controller 416 is also configured to adjust a brightness of the front light guide 406. The controller 416 is further configured to adjust a brightness of a backlight associated with the display unit 402. The controller 416 may adjust the brightness of the front light guide 406 and/or the backlight based on a brightness sensor (not shown). For example, the brightness sensor may be local to the vehicle. The controller 416 additionally configured to switch between the LEDs of the front light guide 406, in the instance wherein there is more than one LED. For example, the controller 416 may switch between the LEDs of the front light guide 406 at a particular frequency based on a type of the LEDs, the desired brightness of the display device 400, and/or the particular setting that is selected.

Referring to FIG. 5, the display device 400 is illustrated as having a surface 500, on which the user 502 can see the displayed image information. For example, the surface 500 may be a display screen of the display device 400. The user 502 may view the display from a viewing direction relative to the display device 400. The viewing angle 414 of the display device 400 is defined as including all directions, in which the user 502 can see the image information on the display device 400. The viewing angle 414 may include the optical projection axis 412, wherein the light is emitted along the optical projection axis 412. A light distribution of the emitted light may be symmetrical to the optical projection axis 412, or in other words, the optical projection axis 412 may be in the center of the viewing angle 414.

Thus, display devices having controllable contrast to limit certain viewing angles are provided. For example, when the display devices have a reduced contrast, viewing becomes difficult, by the user 502, in directions with contrast-controlled light. In one or more embodiments, a bias may be designed into the electro-optical lens 100. For example, the optical projection axis 412 may be offset from perpendicular by an amount when no electrical field is applied to the electro-optical lens 100.

Referring to FIG. 6, as can be seen, the viewing angle corresponds to the light distribution of the emitted light of each of the plurality of pixels 404. Also illustrated is that a light distribution of the electro-optical lens 100 is relative to the optical projection axis 412. For example, the viewing angle 414 may be characterized by a total shape of a light distribution curve. The light distribution curve is a 2D, or a polar, diagram of the light intensity that describes how narrow/broad is the light distribution.

The emitted light of each of the electro-optical lenses 100 of the plurality of electro-optical lenses 302 has a light distribution over angle with a maximum light intensity, or brightness, at 0° along the optical projection axis 412. In each direction, the light intensity is reduced until it reaches 0% of the maximum light intensity at 90° in a plane of the electro-optical lens 100. For example, the viewing angle 414 may be defined as the angle in which the light intensity is above a light intensity threshold value. For example, as is illustrated in FIG. 6, the light intensity threshold value is 50%. Accordingly, the viewing angle 414 includes all directions from −55° to +55°, and is equal to 110°. However, it is understood that the directions may be wider or narrower than −55° to +55° and have ranges that extend beyond 110°. It is understood that the variance of the viewing angle corresponds with the contrast of the display device 400.

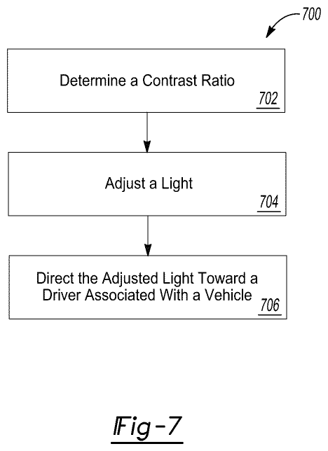

Referring to FIG. 7 a flowchart illustrates an example method 700 for controlling the viewing privacy of a display, such as the display device 400. That is, a switchable privacy display is provided is some examples. At step 702, a contrast ratio is determined. For example, the contrast ratio is determined based on a luminance level. As another example, the contrast ratio is determined based on an ambient light associated with the display device and an ambient light associated with a display device 400. It is understood that the contrast ratio may be determined based on the luminance level absent any ambient light. As an additional example, the contrast ratio may be an ambient contrast ratio. The ambient light is understood as being any light such as from the backlight associated with the display device 400 or a surrounding environment associated with the display device 400. For example, the luminance level indicates an intensity of light emitted from a backlight associated with the display panel.

At step 704, a light is adjusted. For example, the light is adjusted based on the contrast ratio. As another example, the light is emitted from the front light guide 406. As another example, adjusting the light further comprises adjusting a brightness of the light emitted from the front light guide 406. For example, adjusting the brightness of the light emitted from the front light guide 406 is based on the contrast ratio. For example, adjusting the brightness of the light comprises at least one of increasing the brightness of the light or decreasing the brightness of the light.

The front light guide 406 is a film that is comprised of an array of light emitting diodes (LEDs) disposed at one or more edges of the front light guide 406. For example, each of the array of LEDs emit an equal concentration of light. As a further example, the front light guide 406 is disposed between the at least one pixel of the plurality of pixels 404 and a cover lens (i.e., the electro-optical lens 100), wherein the luminance level and the ambient light is associated with the at least one pixel of the plurality of pixels.

At step 706, the adjusted light is directed toward the driver associated with the vehicle. For example, directing the adjusted light toward the driver causes the display device 400 to display an image more visibly to the passenger associated with the vehicle than the driver. Additionally, an updated contrast ratio is determined. For example, the updated contrast ratio is determined based on the light. A concentration of the light directed toward the driver is adjusted. For example, the concentration of the light directed toward the driver is adjusted based on the light. As another example, the concentration of the light directed toward the driver is adjusted based on the updated contrast ratio. For example, in response to a privacy mode setting being selected, such as by a user (i.e., the driver and/or the passenger of the vehicle), one or more settings cause the front light guide 406 to direct a higher concentration of light toward the driver of the vehicle. That is, the passenger of the vehicle will be able to see the contents of the display while the driver of the vehicle will not be able to see the contents of the display.

As an alternative to the utilization of a light guide to improve privacy options for the use of display devices, an addition of a sparkle effect upon the cover lens can be used to better mask and hide the content of the passenger display from the driver. For example, the sparkle effect better masks and hides the content of the passenger display from the driver because it generates an increase of active optical noise. As a further example, instead of a super homogenous light distribution, an artificial texture (e.g., the sparkle effect) can be utilized. It is understood that the artificial texture is based on the position of an illuminating LED (e.g., the light guide). For example, in the case wherein two LEDs, which are based within the same light guide structure and applied to two slightly different textures, the LEDs are driven in sequence, thereby creating a sparkling effect and synchronizes a frequency with a picture frame rate of an image. It is understood that this reduces the visibility of the display content (e.g., the image), especially for sharp edged structures. Another alternative to the utilization of the light guide to improve privacy options for the use of display devices is through the utilization of an red, blue, green (RGB) LED to adjust a traditional front light color to an ambient color scheme instead.

Based on the foregoing, the following provides a general overview of the present disclosure and is not a comprehensive summary.

In a first embodiment A1, a method comprising determining, based on a luminance level and an ambient light associated with a display device, a contrast ratio; adjusting, based on the contrast ratio, a light, wherein the light is emitted from a front light guide; and directing the adjusted light toward a driver associated with a vehicle, wherein directing the adjusted light toward the driver causes the display device to display an image more visibly to a passenger associated with the vehicle than the driver.

In a second embodiment A2, which may include the first embodiment A1, the method further comprises determining, based on the light, an updated contrast ratio; and adjusting, based on the light and the updated contrast ratio, a concentration of the light directed toward the driver. In a third embodiment A3, which may include any combination of the first through second embodiments A1-A2, wherein the luminance level indicates an intensity of light emitted from a backlight associated with the display device. In a fourth embodiment A4, which may include any combination of the first through third embodiments A1-A3, wherein adjusting the light further comprises adjusting, based on the contrast ratio, a brightness of the light emitted from the front light guide, wherein adjusting the brightness of the light comprises at least one of increasing the brightness of the light or decreasing the brightness of the light.

In a fifth embodiment A5, which may include any combination of the first through fourth embodiments A1-A4, wherein the front light guide is a film that is comprised of an array of light emitting diodes (LEDs) disposed at one or more edges of the front light guide. In a sixth embodiment A6, which may include any combination of the first through fifth embodiments A1-A5, wherein the front light guide is disposed between at least one pixel of the plurality of pixels and a cover lens, wherein the luminance level and the ambient light is associated with the at least one pixel of the plurality of pixels. In a seventh embodiment 7, which may include any combination of the first through sixth embodiments A1-A6, wherein each of the array of LEDs emit an equal concentration of light. In an eighth embodiment A8, which may include any combination of the first through seventh embodiments A1-A7, a system comprising a controller configured to determine, based on a luminance level and an ambient light associated with a display device, a contrast ratio, adjust, based on the contrast ratio, a light, wherein the light is emitted from a front light guide, and cause the adjusted light to be directed toward a driver associated with a vehicle, wherein directing the adjusted light toward the driver causes the display device to display an image more visibly to a passenger associated with the vehicle than the driver; and a front light guide configured to direct the adjusted light toward the driver.

In a ninth embodiment A9, which may include any combination of the first through eighth embodiments A1-A8, wherein the controller is further configured to determine, based on the light, an updated contrast ratio; and adjust, based on the light and the updated contrast ratio, a concentration of the light directed toward the driver. In a tenth embodiment A10, which may include any combination of the first through ninth embodiments A1-A9, wherein the luminance level indicates an intensity of light emitted from a backlight associated with the display device. In an eleventh embodiment A11, which may include any combination of the first through tenth embodiments A1-A10, wherein the controller configured to adjust the light is further configured to adjust, based on the contrast ratio, a brightness of the light emitted from the front light guide, wherein adjusting the brightness of the light comprises at least one of increasing the brightness of the light or decreasing the brightness of the light.

In a twelfth embodiment A12, which may include any combination of the first through eleventh embodiments A1-A12, wherein the front light guide is a film that is comprised of an array of light emitted diodes (LEDs) disposed at one or more edges of a film. In a thirteenth embodiment A13, which may include any combination of the first through twelfth embodiments A1-A12, wherein the front light guide is disposed between at least one pixel of the plurality of pixels and a cover lens, wherein the luminance level and the ambient light is associated with the at least one pixel of the plurality of pixels.

In a fourteenth embodiment A14, which may include any combination of the first through thirteenth embodiments A1-A13, wherein each of the array of LEDs emit an equal concentration of light.

In a sixteenth embodiment A15, which may include any combination of the first through fourteenth embodiments A1-A14, one or more non-transitory computer-readable media storing processor-executable instructions that, when executed by at least one processor, cause the at least one processor to determine, based on a luminance level and an ambient light associated with a display device, a contrast ratio; adjust, based on the contrast ratio, a light, wherein the light is emitted from a front light guide; and direct the adjusted light toward a driver associated with a vehicle, wherein directing the adjusted light toward the driver causes the display device to display an image more visibly to a passenger associated with the vehicle than the driver. In a sixteenth embodiment A16, which may include any combination of the first through fifteenth embodiments A1-A15, wherein the at least one processor is further caused to determine, based on the light, an updated contrast ratio; and adjust, based on the light and the updated contrast ratio, a concentration of the light directed toward the driver. In a seventeenth embodiment A17, which may include any combination of the first through sixteenth embodiments A1-A16, wherein the luminance level indicates an intensity of light emitted from a backlight associated with the display device. In an eighteenth embodiment A18, which may include any combination of the first through seventeenth embodiments A1-A17, wherein the front light guide is a film that is comprised of an array of light emitting diodes (LEDs) disposed at one or more edges of the front light guide. In a nineteenth embodiment A19, which may include any combination of the first through eighteenth embodiments A1-A18, wherein the front light guide is disposed between at least one pixel of the plurality of pixels and a cover lens, wherein the luminance level and the ambient light is associated with the at least one pixel of the plurality of pixels. In a twentieth embodiment A20, which may include any combination of the first through nineteenth embodiments A1-A19, adjust, based on the contrast ratio, a brightness of the light emitted from the front light guide, wherein adjusting the brightness of the light comprises at least one of increasing the brightness of the light or decreasing the brightness of the light.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method, comprising:
determining, based on a luminance level and an ambient light associated with a display device, a contrast ratio;
adjusting, based on the contrast ratio, a light, wherein the light is emitted from a front light guide; and
directing the adjusted light toward a driver associated with a vehicle, wherein directing the adjusted light toward the driver causes the display device to display an image more visibly to a passenger associated with the vehicle than the driver.

2. The method of claim 1, further comprising:
determining, based on the light, an updated contrast ratio; and
adjusting, based on the light and the updated contrast ratio, a concentration of the light directed toward the driver.

3. The method of claim 1, wherein the luminance level indicates an intensity of light emitted from a backlight associated with the display device.

4. The method of claim 1, wherein adjusting the light further comprises:
adjusting, based on the contrast ratio, a brightness of the light emitted from the front light guide, wherein adjusting the brightness of the light comprises at least one of increasing the brightness of the light or decreasing the brightness of the light.

5. The method of claim 1, wherein the front light guide is a film that is comprised of an array of light emitting diodes (LEDs) disposed at one or more edges of the front light guide.

6. The method of claim 1, wherein the front light guide is disposed between at least one pixel of a plurality of pixels and a cover lens, wherein the luminance level and the ambient light is associated with the at least one pixel of the plurality of pixels.

7. The method of claim 5, wherein each of the array of LEDs emit an equal concentration of light.

8. A system comprising:
a controller configured to:
determine, based on a luminance level and an ambient light associated with a display device, a contrast ratio,
adjust, based on the contrast ratio, a light, wherein the light is emitted from a front light guide, and
cause the adjusted light to be directed toward a driver associated with a vehicle, wherein directing the adjusted light toward the driver causes the display device to display an image more visibly to a passenger associated with the vehicle than the driver; and
a front light guide configured to:
direct the adjusted light toward the driver.

9. The system of claim 8, wherein the controller is further configured to:
determine, based on the light, an updated contrast ratio; and
adjust, based on the light and the updated contrast ratio, a concentration of the light directed toward the driver.

10. The system of claim 8, wherein the luminance level indicates an intensity of light emitted from a backlight associated with the display device.

11. The system of claim 8, wherein the controller configured to adjust the light is
further configured to:
adjust, based on the contrast ratio, a brightness of the light emitted from the front light guide, wherein adjusting the brightness of the light comprises at least one of increasing the brightness of the light or decreasing the brightness of the light.

12. The system of claim 8, wherein the front light guide is a film that is comprised of an array of light emitted diodes (LEDs) disposed at one or more edges of a film.

13. The system of claim 8, wherein the front light guide is disposed between at least one pixel of a plurality of pixels and a cover lens, wherein the luminance level and the ambient light is associated with the at least one pixel of the plurality of pixels.

14. The system of claim 12, wherein each of the array of LEDs emit an equal concentration of light.

15. One or more non-transitory computer-readable media storing processor-executable instructions that, when executed by at least one processor, cause the at least one processor to:
determine, based on a luminance level and an ambient light associated with a display device, a contrast ratio;
adjust, based on the contrast ratio, a light, wherein the light is emitted from a front light guide; and
direct the adjusted light toward a driver associated with a vehicle, wherein directing the adjusted light toward the driver causes the display device to display an image more visibly to a passenger associated with the vehicle than the driver.

16. The one or more non-transitory computer-readable media of claim 15, wherein the at least one processor is further caused to:
determine, based on the light, an updated contrast ratio; and
adjust, based on the light and the updated contrast ratio, a concentration of the light directed toward the driver.

17. The one or more non-transitory computer-readable media of claim 15, wherein the luminance level indicates an intensity of light emitted from a backlight associated with the display device.

18. The one or more non-transitory computer-readable media of claim 15, wherein the front light guide is a film that is comprised of an array of light emitting diodes (LEDs) disposed at one or more edges of the front light guide.

19. The one or more non-transitory computer-readable media of claim 15, wherein the front light guide is disposed between at least one pixel of a plurality of pixels and a cover lens, wherein the luminance level and the ambient light is associated with the at least one pixel of the plurality of pixels.

20. The one or more non-transitory computer-readable media of claim 15, wherein the processor-executable instructions, that when executed by the at least one processor, adjust the light, further cause the at least one processor to:
adjust, based on the contrast ratio, a brightness of the light emitted from the front light guide, wherein adjusting the brightness of the light comprises at least one of increasing the brightness of the light or decreasing the brightness of the light.
